(19) United States
(12) Patent Application Publication
(10) Pub. No.: US 2015/0318911 A1
(43) Pub. Date: Nov. 5, 2015

(54) Communications Extender

(71) Applicant: Raytheon Company, Waltham, MA (US)

(72) Inventor: Christopher Samios, Garner, NC (US)

(73) Assignee: Raytheon Company, Waltham, MA (US)

(21) Appl. No.: 14/269,460

(22) Filed: May 5, 2014

(51) Int. Cl. H04B 7/14

(52) U.S. Cl. CPC H04B 7/14; H04W 84/18

(57) ABSTRACT

A communications network allows radio communication to be established within radio frequency (RF) shielding structures, such as a ship. The network is compatible with existing handheld radios and can interoperate with existing land mobile radio (LMR) systems. The network includes a plurality of communications extenders configured to form an ad hoc mesh network for propagating voice data. The communications extenders are battery-powered and have a form factor to allow rapid deployment and reconfiguration of the network.

### BACKGROUND

As is known in the art, many ships are largely made of steel, including steel walls, floors, and bulkheads. Thus, radio frequency (RF) communication, which generally requires “line-of-sight” between antennas, is challenging within a ship. Ships have complex onboard radio systems to provide coverage throughout the ship.

At dock, personnel communicate with each other and also with first responders (e.g., fire, police, and other public safety departments) using land mobile radio (LMR) systems. Dock personnel typically use portable (e.g., handheld) radios, whereas first responders use portable radios, mobile radios, and/or stationary radios. As is known, LMR systems are typically incompatible with a ship's onboard radio system, in terms of operating frequency bands and/or modulation scheme. Moreover, onboard systems may be powered offer during before work begins. Thus, personnel inside the ship are prevented from communicating with each other and with first responders.

### SUMMARY

Described herein are systems and techniques to extend the coverage of radio frequency (RF) communications systems into structures having a plurality of RF shields, such as ship. Moreover, the systems and techniques are interoperable with existing land mobile radio (LMR) systems.

In accordance with one aspect of the invention, a method of providing radio frequency (RF) coverage within a structure having RF shields comprises providing a first apparatus within RF communication of a first radio, the first radio located within a structure; providing a second apparatus within RF communication of a second radio and within mesh network communication of the first apparatus, the second radio located within the structure, wherein one or more RF shields located within the structure inhibit RF communication between the first radio and the second radio; forming a wireless mesh network between the first apparatus and the second apparatus; at the first apparatus, receiving an RF audio signal transmitted from the first radio, generating network audio data representative of the received RF audio signal, and sending the generated network audio data into the wireless mesh network; and at the second apparatus, receiving the network audio data from the wireless mesh network, generating an RF audio signal representative of received network audio data, and transmitting the generated RF audio signal to the second radio. In some embodiments, the mesh network comprises a mobile ad hoc network (MANET). In embodiments, the first radio comprises a handheld radio and the second radio comprises a handheld radio.

In embodiments, the method further comprises providing a third apparatus within RF communication of a third radio and within mesh network communication of the second apparatus, wherein one or more RF shields inhibit RF communication between the third radio and the first radio, and between the third radio and the second radio; at the second apparatus, relaying the network audio data to the third apparatus by way of the wireless mesh network; and at the third apparatus, receiving the network audio data from the wireless mesh network, generating an RF audio signal representative of received network audio data, and transmitting the generated RF audio signal to the third radio. In some embodiments, the third radio may be associated with a land mobile radio (LMR) system. In embodiments, the third apparatus comprises a plurality of radios, a mesh network adapter, and a radio-to-network multiconverter coupled to the plurality of radios and the mesh network adapter.

In embodiments, the network audio data comprises Radio over Internet Protocol (RoIP) packets or Voice over Internet Protocol (VoIP) packets. In some embodiments, the first apparatus and the second apparatus each comprise a radio, a mesh network adapter, and a radio-to-network converter coupled to the radio and the mesh network adapter. In embodiments, the first apparatus and the second apparatus further comprise a battery electrically coupled to and configured to power the mesh network adapter, the radio, and the radio-to-network converter. In some embodiments, the radio-to-network converters generate the network audio data using pulse-code modulation (PCM), adaptive differential pulse-code modulation (ADPCM), or Global System for Mobile Communication (GSM).

In accordance with another aspect of the invention, an apparatus comprises a mesh network adapter to send and receive network audio data; a two-way radio to receive and transmit RF audio signals; and a radio-to-network converter comprising a network port coupled to the mesh network adapter and a full-duplex audio port coupled to the radio, wherein in response to receiving an analog audio signal from the radio, the radio-to-network converter generates a representative network audio data for sending by the mesh network adapter.

In accordance with yet another aspect of the invention, an apparatus comprises a mesh network adapter to send and receive network audio data; a plurality of radios to receive and transmit RF audio signals; and a radio-to-network multiconverter comprising a network port coupled to the mesh network adapter and a plurality of full-duplex audio ports, wherein each of the plurality of radios is coupled to a respective one of the plurality of audio ports, wherein in response to receiving an analog audio signal from any one of the radios, the radio-to-network multiconverter generates a representative network audio data for sending by the mesh network adapter.

### BRIEF DESCRIPTION OF THE DRAWINGS

Various embodiments of the concepts, structures, and techniques sought to be protected herein may be more fully understood from the following detailed description of the drawings, in which:

FIG. 1 is a schematic representation of a communications network utilizing communications extenders;

FIG. 2 is a block diagram showing a communications extender for use in the network of FIG. 1;

FIG. 3 is a block diagram showing a radio interconnect system for use in the network of FIG. 1;

FIGS. 4A and 4B are flowcharts showing methods for use within the systems of FIGS. 1-3;

FIG. 5 is a schematic representation of a computer that can form part of systems of FIGS. 1-3.

The drawings are not necessarily to scale, emphasis instead generally being placed upon illustrating the principles of the invention.

### DETAILED DESCRIPTION

Before describing certain embodiments of the invention, some terminology is explained. As used herein, the term “mesh network” refers to any network in which nodes relay data for the network and, thus, generally all nodes can cooperate in distribution of data in the network. A mesh network may be self-configuring (also referred to as “ad hoc”) and self-healing. The term “wireless mesh network” refers to any mesh network in which nodes communicate wirelessly (e.g., through free space). The term “mobile ad hoc network (MANET)” refers to any self-configuring network in which the nodes communicate wirelessly. A MANET may function as a mesh network, but need not do so.

The phrase “within RF communication” is used herein to refer to the potential for two radios to communicate by RF at conventional operating power and frequencies (i.e., the potential for a radio to receive RF signals transmitted by another radio at normal power within conventional frequency bands). The phrase “RF shield” is used to refer to any structure or surface that inhibits RF communication between two or more radios. The phrase “within mesh network communication” is used herein to refer to the potential for two mesh network adapters (i.e., radios) to communicate at conventional mesh networking power levels and frequencies.

As used herein, the term Voice over Internet Protocol (VoIP) refers any technique for delivering voice communications over Internet Protocol (IP) networks, such as the Internet. The term Radio over IP (RoIP) refers to any technique for delivering and/or relaying radio communications through over IP networks. The systems and methods described herein may utilize any VoIP and RoIP techniques known to those skilled in the art.

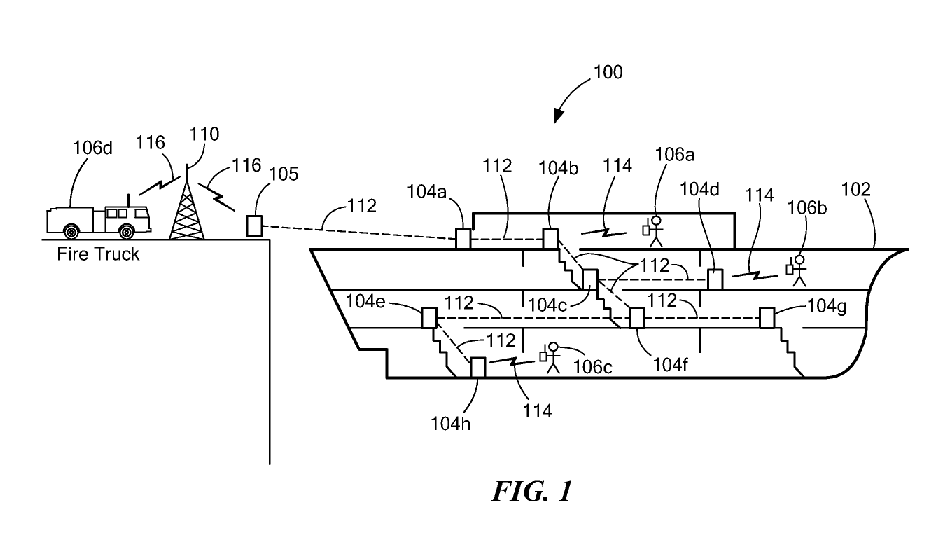

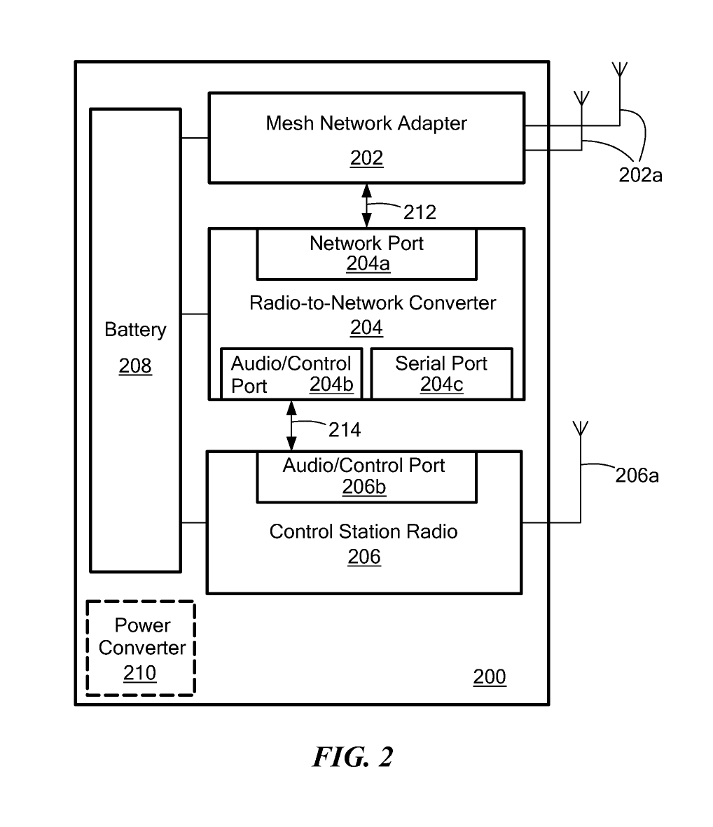

Referring to FIG. 1, a communications network 100 provides radio frequency (RF) coverage within a structure 102 having limited line-of-sight. The structure 102 includes one or more RF shields, such as steel floors, walls, doors, and/or stairs/ladders. In some embodiments, the structure 102 is a ship, although it should be appreciated that the systems and techniques described herein are not limited to use on a ship. For example, the structure 102 could comprise a submarine, a mine, a tunnel, a building, or any other structure that includes RF shields. The network 100 includes a plurality of communications extenders 104 (i.e., 104a-104h) interconnected as a wireless mesh network. An example of a communications extender 104 is described below in connection with FIG. 2.

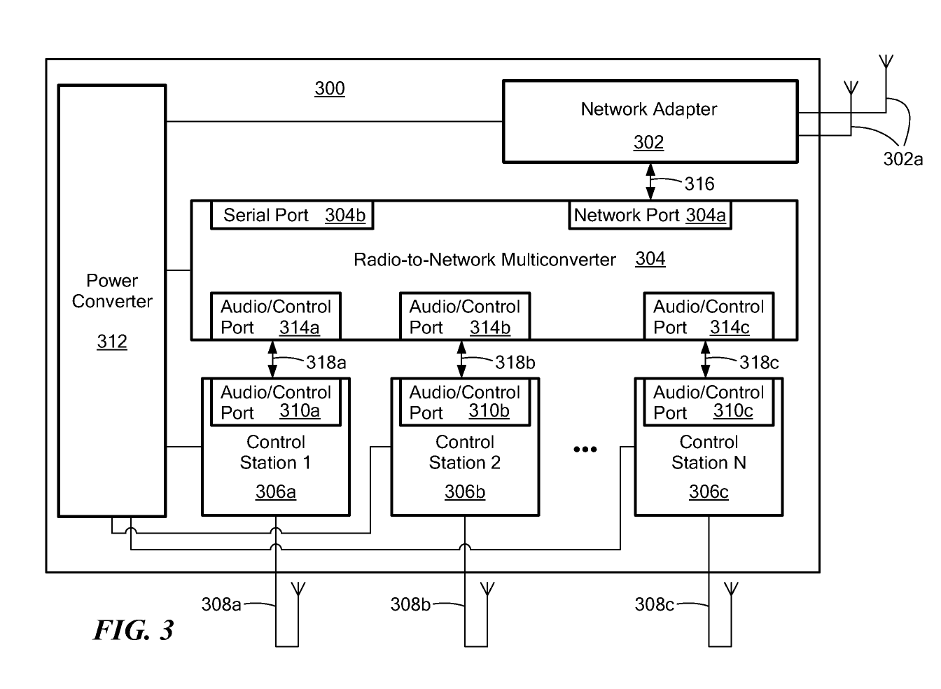

In some embodiments, the network 100 further includes a radio interconnect system (referred to more simply as an “interconnect system”) 105 to provide interoperability with one or more land mobile radio (LMR) systems 110, which are generally located external to the structure 102. For simplicity, only one LMR system 110 is shown in FIG. 1, although it will be appreciated that the systems described herein can operate with many LMR systems at one time. In some embodiments, the LMR systems 110 include fire, police, and other public safety radio systems. An LMR system typically includes a plurality of radios (mobile, handheld, control stations, dispatch equipment, etc.) in RF communication with stationary receivers (“receive sites”), stationary transmitters (“transmit sites”), and/or stationary repeaters (“repeater sites”). An example of an interconnect system is discussed further below in connection with FIG. 3.

Network users 106 (i.e., 106a-106d) can be located inside and/or external to the structure 102. For clarity, the users inside the structure (e.g., 106a-106c) are herein referred to as “onboard users” and the users outside the structure (e.g., 106d) are referred to as “LMR users.” In some embodiments, the LMR users 106d include fire, police, or other public safety personnel. The users 106 generally communicate using two-way radios, which include portable and/or stationary radios operate in VHF, FRS, GMRS, or any other approved frequency band. Typically, the onboard users 106a-106c communicate using handheld radios (sometimes referred to as “handy talkies”). As will be appreciated, the network 100 can be readily adapted to work with many different makes and models of commercial off-the-shelf (COTS) radios.

A communications extender 104 is configured to establish wireless mesh networking links 112 with one or more different communications extenders, and configured to be in RF communication (i.e., to transmit and receive RF audio signals 114) with one or more users 106. Because the structure 102 includes RF shields, at least one extender is generally placed within line of sight of each onboard user 106a-106c (i.e., within line of sight of any location where users are expected). For example, in FIG. 1, communications extender 104c is within line-of-sight of a user 106a and thus RF communication is feasible. In general, each extender is located within line-of-sight of at least one other extender. For example, extender 104d is within line-of-sight of extender 104c and a wireless mesh network link can be established between them.

In general operation, an onboard user 106a-106c transmits an RF audio signal 114, which may comprise a voice signal, using a handheld radio. The transmitted RF audio signal is received by one or more of the communications extenders 104 (i.e., the communication extenders in RF communication with the user's radio). The receiving communications extenders 104 convert the received audio signal into representative network audio data (e.g., RoIP or VoIP data packets), which is transmitted to neighboring communications extenders (i.e., those communications extenders connected thereto by mesh network links 114). A neighboring communications extender receives the network audio data and relays it to its neighbors; this process can be repeated until the network audio data propagates to all communications extenders within the mesh network. When a communications extender receives the network audio data, it also converts it back to an analog audio signal, which is transmitted as an RF signal 114 for reception by the users 106.

In some embodiments, a communications extender 104 receives an audio signal from a user's radio, converts the audio signal into representative network data, and sends the network audio data to a radio interconnect system 105 via the mesh network. In turn, the radio interconnect system 105 routes the network audio data to one or more different communications extenders (i.e., the radio interconnect system 105 may act as a relay).

For example, referring specifically to FIG. 1, a first user 106a may use a handheld radio to transmit an RF audio signal 114 which is received by the communications extender 104b and converted to network audio data. The communications extender 104b relays the network audio data to the extender 104c, which in turn relays the signal to the extender 104d, which in turn converts the network audio data to an analog signal. The analog audio signal is transmitted as RF audio signal 114 and received by a second different user 106b. Thus, the users 106a and 106b can communicate using COTS handheld radios even though they are separated by an RF-shielding steel floor.

To interoperate with one or more LMR systems 110, the network may include an interconnect system 105 configured for compatibility (e.g., frequency bands and modulation schemes) with the LMR systems. The interconnect system 105 is in network communication with one or more of the communications extenders 104. In some embodiments, the interconnect system is part of the wireless mesh network. In another embodiment, the interconnect system 105 is connected to a communications extender (e.g., 104a in FIG. 1) by a wireline network connection, such as Ethernet. In some embodiments, the interconnect system 105 is located outside the structure 102.

In general operation, an LMR user 106d transmits RF audio signals 116 using a portable or stationary radio. The transmitted RF audio signals 116 are received by the LMR system 110, which re-transmits (“repeats”) the signal, typically at a higher power. In turn, the interconnect system 105 receives the repeated RF audio signal 116 and generates representative network audio data (e.g., VoIP or RoIP data packets). The network audio data is propagated to the communications extenders 102 (e.g., using mesh networking) where it is converted and broadcast as an RF audio signal throughout the structure 102.

Thus, it will be appreciated after reading the preceding disclosure that the network 100 enables users inside a structure to communicate with each other, despite the presence of RF shields, by effectively “routing” RF audio signals around such shields. To provide radio coverage throughout the structure, the communications extenders 104 can be placed strategically throughout the structure 102 such that each extender can establish mesh network communications with at least one other communications extender and a signal path can be found between any two nodes (i.e., users and communications extenders) in the network. In general, each communications extender 104 communicates with another in a chain link pattern, positioned throughout the structure so that transmitted RF signals reach all desired areas (e.g., the areas where users are expected). In some embodiments, the communications extenders 104 use MANET techniques allowing the network topology to be easily rearranged and extended. Moreover, the communications network 100 further enables radio communication between users of several LMR systems and users inside the RF-shielding structure 102. For example, a dock worker inside a ship can use a COTS handheld radio to communicate with fire and police located many miles away. The systems and techniques described herein can be used to extend the range an LMR system and provide coverage within RF-shielding structures, such as ships, buildings, and mines.

In embodiments, the communications network 100 includes a backhaul network and a switch through which all audio network audio data (e.g., packetized audio) traverses. For example, the backhaul network may comprise the communications extenders 104 and the main switch may comprise the interconnect system 105.

It should be understood that the systems and techniques described herein are not limited to the network topology shown in FIG. 1 and can generally include any number of communications extenders and interconnect systems, and can be used by generally any number of LMR users, onboard users, and can interoperate with several different LMR systems.

Referring now to FIG. 2 a communications extender 200 may be the same as or similar to a communications extender 104 of FIG. 1. The communications extender 200 includes a mesh network adapter 202, a radio-to-network converter 204, and a control station radio (referred to more simply as a “control station”) 206. The mesh network adapter 202 and the control station 206 are in signal communication with the radio-to-network converter 204, as discussed further below. The communications extender 200 may include a housing having a form factor to allow easy placement and rapid deployment of extenders throughout a structure (e.g., a ship). In embodiments, the communications extender 200 is housed in a “pelican style” industrial case. The communications extender 200 housing may have a length between 12 and 24 inches, a width between 8 and 20 inches, and a height between 4 and 12 inches.

The communications extender 200 also includes a battery 208 electrically coupled to mesh network adapter 202, the radio-to-network converter 204, and the control station 206 and configured to power those components. The battery 208 may have sufficient capacity to power the components 202-206 for up to eighteen hours with normal use. In some embodiments, the communications extender 200 includes a power converter (commonly referred to as a “power supply”) 210, such as a 120 VAC power supply with DC voltage outputs. In some embodiments, the communications extender 200 includes a battery 208 and a power converter 210, wherein the power convert is configured to recharge the battery.

The mesh network adapter 202 can be any type of wireless mesh networking adapter, such as such as a StreamCaster 3500 mesh radio, distributed by Silvus Technologies, Inc. of Los Angeles, Calif. USA; a MCU-30 wireless IP radio distributed by Mobilicom Ltd. of Azor, Israel. In some embodiments, the mesh networking adapter supports ad-hoc operation, for self-forming, self-healing network communications. The mesh network adapter 202 includes one or more antennas 202a, as shown. In some embodiments, the mesh network adapter 202 includes a plurality of antennas for multiple-input and multiple-output (MIMO) operation. The antenna 202a may comprise any suitable type of omnidirectional or a directional antenna (e.g., Yagi-type antenna).

The control station 206 is a two-way radio compatible, in terms of modulation scheme and frequency bands, with handheld radios used by the onboard users 106. The control station 206 may comprise a low-power, COTS radio, such as an APX6500, a CMD750, or a MCS2000, each of which is distributed Motorola Solutions, Inc. of Schaumburg, Ill. USA. The communications extender 200 also includes a radio antenna 206a coupled to the control station 206 for receiving and transmitting RF signals. The radio antenna 206a may comprise an omnidirectional antenna or a directional antenna. In general, the type of control station and antenna are selected based upon the type of handheld radios used by the onboard users 106. The control station 206 may be configured to transceiver on a selected frequency band (i.e., a selected channel) used by the onboard user radios. It should be understood that a communications network (e.g., network 100 in FIG. 1) can utilize several different types of control stations to provide interoperability with different types of handheld radios.

The radio-to-network converter 204 comprises a special purpose computing system that includes various hardware and software components configured as described herein. The radio-to-network converter may have several interfaces, including a network port 204a and a full-duplex audio port 204b. The mesh network adapter 202 is coupled to the network port 204a via a network connector 212. In some embodiments, the network port 204a comprises an RF-45 connector, and the network connector 212 comprises a 10/100BASE-T Ethernet cable.

The control station 206 is coupled to the radio-to-network converter 204 via an audio link 214, which may support full-duplex audio communication. The audio link 214 connects to an audio port 206b of the control station and to the audio port 204b of the radio-to-network converter. In some embodiments, the audio link 214 also allows control signals to be sent between the control station and the radio-to-network converter. Thus, the audio link 214 may be referred to as an “audio/control link” and the audio ports 204b, 206b may be referred to as “audio/control ports.” In other embodiments, the control station is coupled to the radio-to-network converter by separate audio and control links. In some embodiments, the full-duplex audio ports comprise separate input and output audio ports. In some embodiments, the audio/control ports 206b, 204b and the audio/control link 214 utilize D-subminiature (“D-sub”) type connectors, such as DB-15 connectors, whereby one or pins/lines corresponding to audio input, one or more pins/lines correspond to audio output, and one or more pins/lines are used for control signals.

In some embodiments, the radio-to-network converter 204 is configured to receive a Carrier Operated Relay (COR) control signal from the control station 206 to determine when the audio input is active, i.e., when a received audio signal should be transmitted through the network. In embodiments, the radio-to-network converter 204 determines when the audio input is active using audio signal detection techniques. For example, according to one such technique, referred to as Voice Operated Switching (VOX), the audio input is deemed active if the input signal level is above a predetermined threshold level. To prevent VOX from dropping between words spoken by a user, the radio-to-network converter may consider an audio signal active for a predetermined amount of time after the signal drops below the threshold level.

In some embodiments, the radio-to-network converter 204 also includes a serial port 204c to connect to a computer for configuring the radio-to-network converter. In embodiments, the serial port 204c comprises a female RS-232 DB-9 connector. The radio-to-network converter 204 may allow a user to change or control a radio channel using a graphical user interface (GUI). The radio-to-network converter 204 can be configured using a built-in GUI. Non-limiting examples of configuration options supported by the radio-to-network converter 204 include: setting the serial port baud rate, setting the broadcast mode (e.g., normal, connectionless, or multicast), setting network configuration options (e.g., Internet Protocol (IP) address), selecting COR or VOX mode, selecting a voice compression method (e.g., pulse-code modulation (PCM) 64 Kbps, adaptive differential pulse-code modulation (ADPCM) 16 Kbps, ADPCM 24 Kbps, or ADPCM 32 Kbps), setting receive and transmit delays, and selecting full- or half-duplex mode. The radio-to-network converter 204 may also include multiple communications modes, such as client-server, connectionless, and multicast; however, it should be appreciated that multicast is typically used with the techniques and systems sought to be protected herein. In embodiments, the radio-to-network convert 204 is configured to generate Global System for Mobile Communication (GSM) data.

In one embodiment, the radio-to-network converter 204 comprises and/or is based upon an NXU-2A Network Extension Unit, designed and manufactured by Raytheon Company, Raleigh, N.C. A detailed description of the structure, configuration, and operation of an NXU-2A is given in the NXU-2A Installation and Operations Manual Revision 1.3 published February, 2009 and available from Raytheon Company's website (http://www.raytheon.com). The NXU-2A Installation and Operations Manual is incorporated herein by reference in its entirety.

In general operation, the communications extender 200 can function as an RF receiver and an RF transmitter. As an RF receiver, the control station 206 receives an RF audio signal from a user radio via the radio antenna 206a. The control station 204 demodulates the RF audio signal to generate a baseband signal, which is output on its audio/control port 206b. In some embodiments, the control station 204 also generates and outputs a COR indicator signal on the audio/control port 206b. In response, the radio-to-network converter 204 receives the baseband audio signal at its audio/control port 204b. The radio-to-network converter 204 determines whether the audio input is active based on, for example, a COR indicator signal or VOX. If the audio input is active, the radio-to-network converter 204 generates network audio data representative of the received analog baseband audio signal, and propagates the network audio data to other communications extenders in the network via the mesh network adapter 202. The radio-to-network converter 204 may apply digital signal processing (DSP) techniques to the generated network audio data, including voice compression and/or a transmit delay.

In one embodiment, the network audio data comprises VoIP and/or RoIP packets. The radio-to-network converter 204 may use IP multicast to route the IP packets to a plurality of other communications extenders in the network. Whereby a common multicast IP address is assigned to most of (and ideally all of) the communications extenders in the network, the radio-to-network converter 204 can effectively broadcast the network audio data throughout the network. In some embodiments, the radio-to-network converter 204 sends the IP packets to a multicast group identified by a single Class D IP address.

In some embodiments, the network uses IP unicast, whereby each communications extender is assigned a unique IP address and a radio interconnect system (e.g., interconnect system 105 of FIG. 1) acts as a relay, receiving network audio data from a communications extender and sending the network audio data to one or more different communications extenders.

The communications extender 200 can also function as an RF transmitter. Here, radio-to-network converter 204 receives (via the mesh network adapter 202) network audio data sent through the network. The radio-to-network converter 204 converts the network audio data into a baseband analog audio signal, which is provided as output at its audio/control port 204b. The control station 206 receives the baseband signal at its audio/control port 206b, modulates the signal to generate an RF audio signal, and transmits the RF signal via the radio antenna 206a for reception by user radios. Thus, it should be appreciated that a first user's radio transmissions received at a communications extender 200 can be automatically relayed to one or more other communications extenders for re-transmission and reception by second different user.

Referring now to FIG. 3, an interconnect system 300 may be the same as or similar to the interconnect system 105 shown in FIG. 1. The system 300 includes a mesh network adapter 302, a radio-to-network multiconverter 304, one or more control stations 306 (e.g., 306a-306c), and a power converter 312. The interconnect system 300 also includes a power converter (i.e., a power supply) 312 electrically coupled to network adapter 302, the radio-to-network multiconverter 304, and the control stations 306, as shown. In some embodiments, the power converter 312 includes a 120 VAC input and DC voltage outputs.

The network adapter 302 may comprise any suitable wireless or wireline network adapter. In some embodiments, the network adapter 302 is a mesh network adapter configured to communicate with one or more communications extenders 104 (FIG. 1). Thus, the network adapter 302 and a corresponding antenna 302a may be the same as or similar to the adapter 202 and antenna 202a, respectively, described above in connection with FIG. 2. In another embodiment, the network adapter 302 is an Ethernet adapter hardwired to a communications extender. Thus, the interconnect system 300 may be directly connected to a mesh network, or indirectly connected via a communications extender.

The control stations 306a-306c include respective antennas 308a-308c and audio/control ports 310a-310c. A control station 306 may be the same as or similar to the control station 206 described above in connection with FIG. 2. A control station 306 may be compatible with, in terms of frequency band and modulation scheme, an LMR system 110 (FIG. 1). In embodiments, a first control station 306a is be configured to operate with a first LMR system (e.g., fire) and a second control station 306b is configured to operate with a second LMR system (e.g., police). In some embodiments, a single control station is compatible with multiple LMR systems. In general, the interconnect system 300 can include any number of control stations 306 to provide compatibility with any number of LMR systems.

The radio-to-network multiconverter 304 comprises a special purpose computing system that includes various hardware and software components configured as described herein. The radio-to-network multiconverter 304 includes a network port 304a and one or more full-duplex audio ports 314 (i.e., 314a-314c). The network adapter 302 is coupled to the network port 304a via a network connector 316, which may be the same as or similar to the network connector used within a communications extender (e.g., communications extender 212 in FIG. 2).

The control stations 306a-306c are coupled to the radio-to-network multiconverter 304 via respective audio/control links 318a-318c, which support full-duplex audio communication. The audio/control links 318a-318c connect audio/control ports 310a-310c of the control stations to respective audio/control ports 314a-314c of the radio-to-network multiconverter, as shown. The audio/control links and ports used within the interconnect system 300 may be the same as or similar to the audio/control links and ports used within the communications extender 200, as discussed above in connection with FIG. 2.

The radio-to-network multiconverter 204 may be configured to receive a COR indicator signal from the control stations and/or to perform audio signal detection (e.g., VOX). In some embodiments, the radio-to-network multiconverter 304 can be configured by a computer connected via a serial port 304b (e.g., a female RS-232 DCE DB-9 connector).

In some embodiments, the radio-to-network multiconverter 304 comprises and/or is based upon an ACU-1000 Intelligent Interconnect System, designed and manufactured by Raytheon Company, Raleigh, N.C. A detailed description of the structure, configuration, and operation of an ACU-1000 is given in the ACU-1000 Installation and Operations Manual Revision 4.4 published July, 2010 and available from Raytheon Company's website (http://www.raytheon.com). The ACU-1000 Installation and Operations Manual is incorporated herein by reference in its entirety. Similar to the communications extender 200 (FIG. 2), the interconnect system 300 can function as an RF receiver and an RF transmitter. As an RF receiver, a control station (e.g., 306a) receives an RF audio signal from an LMR system (or LMR user) via a radio antenna (e.g., 308a). The control station 306a demodulates the received RF audio signal to generate a baseband audio signal (and, in some embodiments, a COR indicator signal), which is output at its audio/control port 310a. The radio-to-network multiconverter 304 receives the baseband audio signal at the corresponding audio/control port (e.g., 314a) and can determine the port's audio input is active (e.g., using a COR indicator signal or VOX). In response, the radio-to-network multiconverter 304 converts the baseband signal to network audio data for transmission through the network (via the network adapter 302). The multiconverter 304 may also be directly connected to one or more radio systems and, thus, may send the RF audio signal directly to those radios (i.e., it may operate in a “hybrid” mode). The radio-to-network conversion process may use any of the is techniques described above in connection with the radio-to-network converter 204 of FIG. 2.

The interconnect system 300 can also function as an RF transmitter. Here, radio-to-network multiconverter 304 receives network audio data, via the network adapter 302, sent through the network. The radio-to-network multiconverter 304 converts the network audio data into a baseband analog audio signal, which is provided as output at one or more of the audio/control port 314. In one embodiment, the radio-to-network multiconverter 304 provides the baseband audio signal as output at one or more of the audio/control output ports 314 to be received by one or more corresponding control stations. The receiving control stations transmit the signal as an RF audio signal, which may be received by one or more LMR system/user. In some embodiments, the radio-to-network multiconverter 304 generally outputs the baseband audio signal to all the audio/control ports 314b.

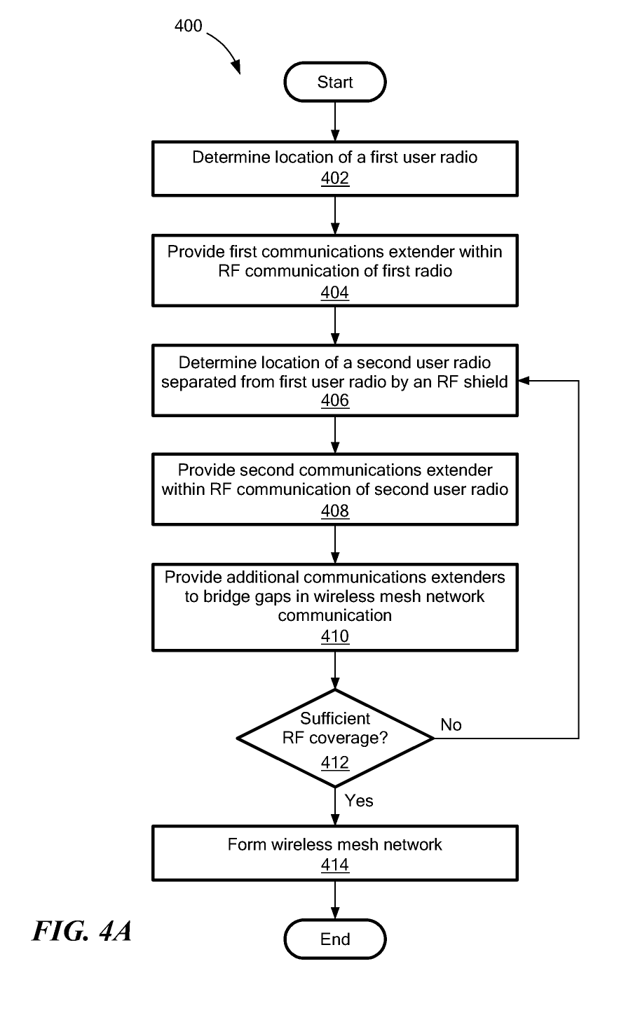

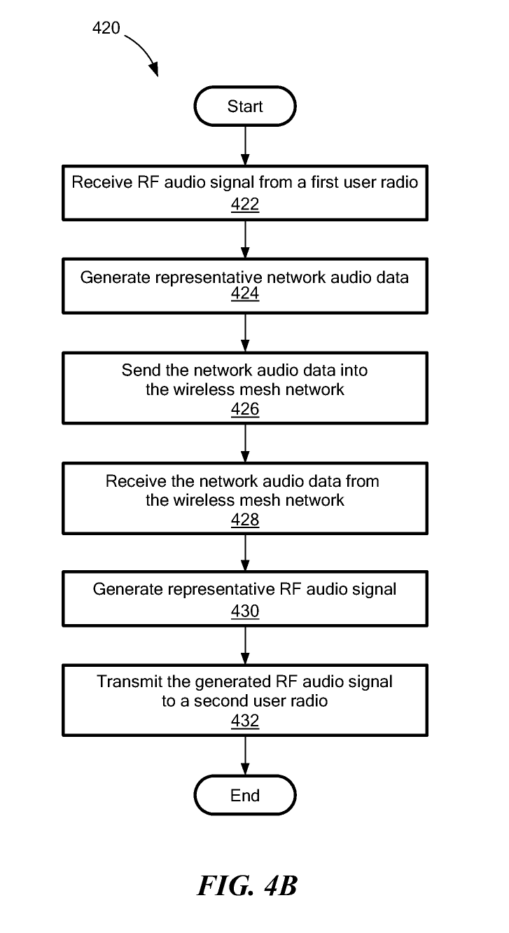

FIGS. 4A and 4B are flowcharts corresponding to examples of processes implemented within a communications extender 200 (FIG. 2) and/or a radio interconnect system 300 (FIG. 3). Rectangular elements (typified by element 402 in FIG. 4A), herein denoted “processing blocks,” represent computer software instructions or groups of instructions. Alternatively, the processing blocks represent steps performed by functionally equivalent circuits such as a digital signal processor circuit. The flow diagrams do not depict the syntax of any particular programming language. Rather, the flow diagrams illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied without departing from the spirit of the systems and methods sought to be protected herein. Thus, unless otherwise stated the blocks described below are unordered meaning that, when possible, the steps can be performed in any convenient or desirable order.

Referring to FIG. 4A, a method 400 may be used to form a communications network within a structure having RF shields, such the network 100 of FIG. 1. At block 402, is the location of a first user radio (e.g., a handheld radio) is determined. This determination can be based on actual user locations and/or expected user locations. For example, within a ship, users may be expected in any room, stairwell, or other type of passageway. At block 404, a first communications extender (such as apparatus 200 of FIG. 2) is provided within RF communication (e.g., within line-of-sight) of the determined first user radio. At block 406, the location of a second user radio is determined. In general, the determined first and second radio locations are separated by an RF shield (i.e., RF communication would be inhibited between radios at those two locations). At block 408, a second communications extender is positioned within RF communication of the second user radio. At block 410, one or more additional communications extenders may be provided as needed to form a wireless mesh network between the first and second communications extended. Thus, if the first and second communications extenders are within mesh network communication, block 410 can be skipped. In general, the additional communications extenders may be provided in a “chain-link” topology.

The processing of blocks 402-410 is repeated as needed to provide RF coverage around all expected user radio locations (e.g., within every room and passageway of a ship). At decision block 412, if sufficient RF coverage has been provided, processing continues to block 414, where a wireless mesh network is formed among the communications extenders. This involves each of the provided communications extenders connecting to at least one other communications extender using a mesh network adapter. The formed mesh network may be a MANET.

In some embodiments, the method 400 further comprises providing a radio interconnect system (such as apparatus 300 of FIG. 3). The radio interconnect system is located to be in RF communication with one or more LMR systems and within wireless mesh network communication of at least one of the communications extenders (thus, the interconnect system is typically located outside the structure). Thus, at block 414, the radio interconnect system may connect to at least one communications extender using a mesh network adapter.

Referring to FIG. 4B, a method 420 corresponds to processing that may be performed within a communications extender (e.g., apparatus 200 of FIG. 2) and/or within a radio interconnect system (e.g., apparatus 300 of FIG. 3). At block 422, an RF audio signal is received from a first user radio (e.g., from a user's handheld radio). At block 424, network audio data, representative of the received RF audio signal, is generated. The network audio data may comprise VoIP or RoIP packets. In embodiments, the network audio data is compressed, delayed, and/or otherwise processed. At block 426, the generated network audio data is sent into the wireless mesh network. At block 428, the network audio data is received from the wireless mesh network. At block 430, an RF audio signal, representative of the received network audio data, is generated. At block 432, the generated RF audio signal is transmitted to a second user radio. It should be appreciated that processing blocks 422-426 may be performed by a first apparatus and, in response, blocks 428-432 could be performed by a second different apparatus.

It is understood that embodiments of systems and techniques to extend the coverage of radio frequency (RF) communications systems into structures having a plurality of RF shields have a wide variety of applications in which it is desirable to overcome RF shields in establishing RF communications. While embodiments are described in conjunction with a ship, it is understood that many structures have various RF shielding structures that can impede communications. For example, large vehicles, buildings, warehouses, skyscrapers, and the like can include various features that impede RF communications. In emergency, or other situations, it may be desirable to establish communications within the structure. For example, a first RF apparatus can be placed external to a skyscraper at some distance and other RF apparatus can be placed on one or more floors in locations to enable mesh communication with the first apparatus. Such an arrangement may provide communication within the building to firefighters, or other emergency personnel. Other applications within the scope of the claimed invention will be readily apparent to one of ordinary skill in the art.

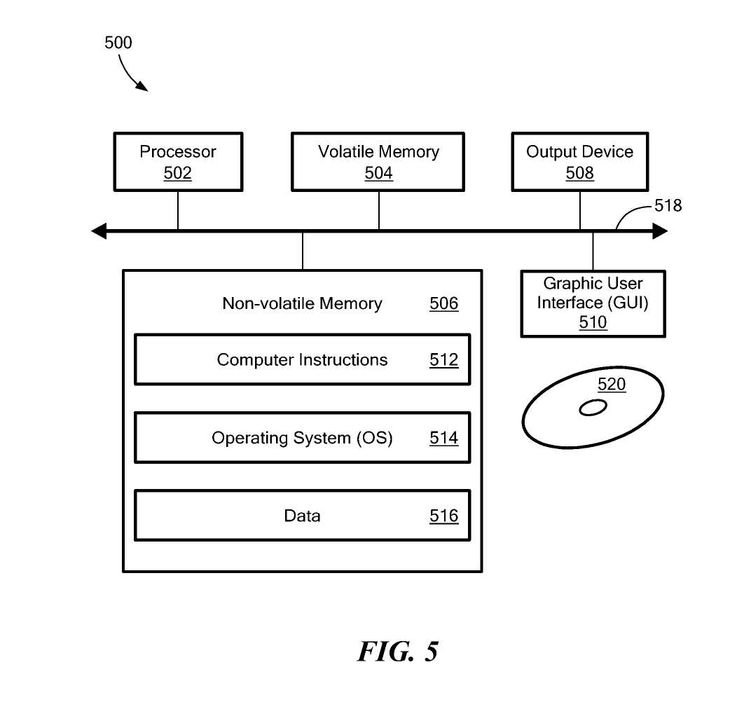

FIG. 5 shows a computer 500 that can perform at least part of the processing described herein. The computer 500 includes a processor 502, a volatile memory 504, a non-volatile memory 506 (e.g., hard disk), an output device 508 and a graphical user interface (GUI) 510 (e.g., a mouse, a keyboard, a display, for example), each of which is coupled together by a bus 518. The non-volatile memory 506 stores computer instructions 512, an operating system 514, and data 516. In one example, the computer instructions 512 are executed by the processor 502 out of volatile memory 504. In one embodiment, an article 620 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as special purpose logic circuitry.

All references cited herein are hereby incorporated herein by reference in their entirety.

Having described certain embodiments, which serve to illustrate various concepts, structures and techniques sought to be protected herein, it will now become apparent to those of ordinary skill in the art that other embodiments incorporating these concepts, structures, and techniques may be used. Accordingly, it is submitted that that scope of the patent should not be limited to the described embodiments but rather should be limited only by the spirit and scope of the following claims.

What is claimed is:

1. A method of providing radio frequency (RF) coverage within a structure having RF shields, the method comprising:
providing a first apparatus within RF communication of a first radio, the first radio located within a structure;
providing a second apparatus within RF communication of a second radio and within mesh network communication of the first apparatus, the second radio located within the structure, wherein one or more RF shields located within the structure inhibit RF communication between the first radio and the second radio;
forming a wireless mesh network between the first apparatus and the second apparatus;
at the first apparatus, receiving an RF audio signal transmitted from the first radio, generating network audio data representative of the received RF audio signal, and sending the generated network audio data into the wireless mesh network; and
at the second apparatus, receiving the network audio data from the wireless mesh network, generating an RF audio signal representative of received network audio data, and transmitting the generated RF audio signal to the second radio.

2. The method of claim 1 further comprising:
providing a third apparatus within RF communication of a third radio and within mesh network communication of the second apparatus, wherein one or more RF shields inhibit RF communication between the third radio and the first radio, and between the third radio and the second radio;
at the second apparatus, relaying the network audio data to the third apparatus by way of the wireless mesh network; and
at the third apparatus, receiving the network audio data from the wireless mesh network, generating an RF audio signal representative of received network audio data, and transmitting the generated RF audio signal to the third radio.

3. The method of claim 2 wherein the third radio is associated with a land mobile radio (LMR) system.

4. The method of claim 1 wherein the network audio data comprises Radio over Internet Protocol (RoIP) packets or Voice over Internet Protocol (VoIP) packets.

5. The method of claim 1 wherein the first apparatus and the second apparatus each comprise a radio, a mesh network adapter, and a radio-to-network converter coupled to the radio and the mesh network adapter.

6. The method of claim 5 wherein the first apparatus and the second apparatus further comprise a battery electrically coupled to and configured to power the mesh network adapter, the radio, and the radio-to-network converter.

7. The method of claim 2 wherein the third apparatus comprises a plurality of radios, a mesh network adapter, and a radio-to-network multiconverter coupled to the plurality of radios and the mesh network adapter.

8. The method of claim 1 wherein the mesh network comprises a mobile ad hoc is network (MANET).

9. The method of claim 5 wherein the radio-to-network converters generate the network audio data using pulse-code modulation (PCM), adaptive differential pulse-code modulation (ADPCM), or Global System for Mobile Communication (GSM).

10. The method of claim 1 wherein the first radio comprises a handheld radio and the second radio comprises a handheld radio.

11. An apparatus comprising:
a mesh network adapter to send and receive network audio data;
a two-way radio to receive and transmit RF audio signals; and
a radio-to-network converter comprising a network port coupled to the mesh network adapter and a full-duplex audio port coupled to the radio, wherein in response to receiving an analog audio signal from the radio, the radio-to-network converter generates a representative network audio data for sending by the mesh network adapter.

12. The apparatus of claim 11 wherein, in response to receiving network audio data from the mesh network adapter, the radio-to-network converter generates a representative analog audio signal for transmission by the radio.

13. The apparatus of claim 11 wherein the network audio data comprises RoIP packets or VoIP packets.

14. The apparatus of claim 11 further comprising a battery electrically coupled to and configured to power the mesh network adapter, the radio, and the radio-to-network converter.

15. The apparatus of claim 11 wherein the mesh network adapter is configured to form a MANET.

16. The apparatus of claim 11 wherein the radio-to-network converter generates the network audio data using PCM, ADPCM, or GSM.

17. The apparatus of claim 11 wherein the two-way radio is the first of a plurality of radios to receive and transmit RF audio signals, wherein in response to receiving network audio data from the mesh network adapter, the radio-to-network converter generates a representative analog audio signal for transmission by at least two of the radios.

18. The apparatus of claim 1 wherein the radio is configured to receive RF audio signals from a handheld radio and to transmit RF audio signals to a handheld radio.

19. The apparatus of claim 17 wherein at least one of the plurality of radios receives RF audio signals from an LMR system radio.

20. An apparatus comprising:
a mesh network adapter to send and receive network audio data;
a plurality of radios to receive and transmit RF audio signals; and
a radio-to-network multiconverter comprising a network port coupled to the mesh network adapter and a plurality of full-duplex audio ports, wherein each of the plurality of radios is coupled to a respective one of the plurality of audio ports, wherein in response to receiving an analog audio signal from any one of the radios, the radio-to-network multiconverter generates a representative network audio data for sending by the mesh network adapter.
